(19) United States
(12) Patent Application Publication
(10) Pub. No.: US 2026/0025465 A1
(43) Pub. Date: Jan. 22, 2026

(54) Dynamic Context-Aware Dispatching

(71) Applicant: American TEL-A-Systems, Inc., McFarland, WI (US)

(72) Inventors: Thomas V. Curtin, Madison, WI (US); Kevin Mark Beale, Stoughton, WI (US); Daniel R. Cropp, McFarland, WI (US); Paul L. Hansen, McFarland, WI (US); Wayne Paul Waldner, Richland Center, WI (US); Christopher Richard Bach, Madison, WI (US)

(21) Appl. No.: 18/777,068

(22) Filed: Jul. 18, 2024

(51) Int. Cl. H04M 3/523; H04M 3/51

(52) U.S. Cl. CPC H04M 3/5233; H04M 3/5108

(57) ABSTRACT

The disclosure relates to a system and method for dynamic context-aware dispatching where an applications server is communicatively coupled to an analytics engine. The applications server monitors a communication session, obtains information about an actual call flow of the communication session, and sends the obtained information about the actual call flow of the communication session to the analytics engine. The analytics engine determines, based on an analysis of the obtained information about the actual call flow of the communication session, a routing address for the communication session, where the determination occurs during the communication session.

### TECHNICAL FIELD

The present disclosure relates, in general, to communication systems and, more particularly, to systems and methods for dynamic context-aware dispatching.

### BACKGROUND

Call-centers are designed to connect callers to agents or other company representatives for a variety of purposes. Business owners may require call-center services to manage incoming calls, including calls from prospective and existing customers. During some calls, customers leave messages with call center agents and expect the call center agent to deliver that message to an appropriate dispatched party (e.g., a patient's doctor or the head of a particular department at a business). During other calls, customers expect to be connected directly with the appropriate dispatched party after intake with an agent. Customer experiences with call-centers are important to the success of the business. For example, if a prospective customer encounters difficulty being connected to the business' sales team, the business owner may lose a sale. As another example, if a customer's message or call is dispatched to the wrong dispatched party or if the dispatched party does not appropriately handle the customer's concern, the customer may become angry or dissatisfied with the business. For at least these reasons, it is important that call centers, through their agents, quickly and accurately dispatch customer's messages or calls to the correct dispatched party to ensure the quality and consistency of the customer experience.

Systems have been developed to facilitate call-center dispatching and call monitoring. However, existing systems for routing calls at a call-center suffer from significant deficiencies. For example, existing approaches often rely on pre-defined or static routing lists that do not consider the specific context of a communication session. These pre-defined lists result in inefficiencies. For example, it often takes additional steps to identify an appropriate dispatched party for routing a call after a call is improperly routed to an inappropriate dispatched party. These extra steps may cause delay which, in turn, may result in additional expense for the client, customer dissatisfaction, or wasted resources-all of which may be harmful to the business.

Another problem with existing approaches for dispatching is that the determination of where to route a call or message is often done only after a communication session is finished. Waiting until the end of a communication session to determine the correct recipient of a patient's message or future call may cause customers to become dissatisfied with the process because they desire an immediate resolution to their concern.

Another problem with existing systems is that they do not measure or track the effectiveness of a dispatched party after they connect with a customer. Some dispatched parties lack effective communication skills with respect to at least some potential classes of caller. Poor communication on the part of the dispatched party may result in customer dissatisfaction and thus the dispatched party's communication skill should be improved, or the dispatching determination should consider the potential lack of skill.

Yet, another problem with existing systems is that they often rely on dispatched parties utilizing specialized hardware integrated with the dispatching system. This can lead to several issues including limited accessibility due to not all dispatched parties having access to the required specialized hardware at all relevant times (thereby limiting the reach and effectiveness of the system), high costs associated with purchasing, installing, and maintaining specialized hardware, and scalability issues.

### SUMMARY OF EXAMPLE EMBODIMENTS

According to embodiments of the present disclosure, the above-described disadvantages associated with existing call dispatching and monitoring systems may be reduced or eliminated.

In accordance with a particular embodiment of the present disclosure, a system includes an applications server communicatively coupled to an analytics engine. The applications server may be configured to monitor a communication session, obtain information about an actual call flow of the communication session, and send the obtained information about the actual call flow of the communication session to the analytics engine. The analytics engine may be configured to determine, based on an analysis of the obtained information about the actual call flow of the communication session, a routing address for the communication session. The determination may occur during the communication session.

In some embodiments, the routing address is associated with a user.

In some embodiments, the applications server is further configured to transmit a connection request to the user using the routing address.

In some embodiments, the applications server is further configured to connect the user to the communication session.

In some embodiments, the determination of the routing address for the communication session is further based on a characteristic of the user.

In some embodiments, the characteristic is a technical skill associated with the user.

In some embodiments, the analytics engine is further configured to evaluate a performance of the user based on obtained information about the actual call flow of the communication session received after the user has connected to the communication session.

In accordance with another aspect of the present disclosure, a method includes monitoring a communication session, obtaining information about an actual call flow of the communication session, sending the obtained information about the actual call flow of the communication session to an analytics engine, and determining, based on an analysis of the obtained information about the actual call flow of the communications system, a routing address for the communication session. The determining step may occur during the communication session.

In some embodiments, the routing address is associated with a user.

In some embodiments, the method further includes transmitting a connection request to the user using the routing address.

In some embodiments, the method further includes connecting the user to the communication session.

In some embodiments, the determination of the routing address for the communication session is further based on a characteristic of the user.

In some embodiments, the characteristic is a technical skill associated with the user.

In some embodiments, the method further includes evaluating a performance of the user based on obtained information about the actual call flow of the communication session received after the user has connected to the communication session.

In accordance with another aspect of the present disclosure, a non-transitory computer readable medium may have stored therein a program which, when executed by a processor, causes the processor to perform a method. The method includes monitoring a communication session, obtaining information about an actual call flow of the communication session, sending the obtained information about the actual call flow of the communication session to an analytics engine, and determining, based on an analysis of the obtained information about the actual call flow of the communications system, a routing address for the communication session. The determining step may occur during the communication session.

In some embodiments, the routing address is associated with a user.

In some embodiments, the method further includes transmitting a connection request to the user using the routing address.

In some embodiments, the method further includes connecting the user to the communication session.

In some embodiments, the determination of the routing address for the communication session is further based on a characteristic of the user.

In some embodiments, the method further includes evaluating a performance of the user based on obtained information about the actual call flow of the communication session received after the user has connected to the communication session.

Other technical advantages of the present disclosure will be readily apparent to one skilled in the art from the following figures, descriptions, and claims. For example, by eliminating the need for specialized hardware according to certain embodiments described herein, the system may advantageously provide greater accessibility to dispatched parties, reduce costs (for example those related to purchasing, installing, and maintaining the system), and provide greater scalability. Moreover, while specific advantages have been enumerated above, various embodiments may include all, some, or none of the enumerated advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram of an example communication system, in accordance with certain embodiments;

FIG. 2 is a signal diagram of an exemplary process, in accordance with certain embodiments;

FIG. 3 is a flow diagram of an exemplary method, in accordance with certain embodiments.

### DETAILED DESCRIPTION

As described above, existing systems for the dispatching and monitoring of calls in a call center suffer from several significant deficiencies and inefficiencies. For example, existing approaches often rely on pre-defined routing lists that do not consider the specific context of the communication session, make the determination of where to route a message or call after the communication session concludes, fail to measure or track the effectiveness of a dispatched party after connecting with a caller, and often require specialized hardware implemented in the system. The present disclosure contemplates various embodiments that may address these and other deficiencies associated with existing approaches.

For example, in some embodiments, the techniques described herein relate to a system, the system including: an applications server communicatively coupled to an analytics engine, wherein: the applications server is configured to: monitor a communication session; obtain information about an actual call flow of the communication session; and send the obtained information about the actual call flow of the communication session to the analytics engine; and the analytics engine is configured to: determine, based on an analysis of the obtained information about the actual call flow of the communication session, a routing address for the communication session, wherein the determination occurs during the communication session. In some embodiments, the routing address is associated with a user. In some embodiments, the applications server is further configured to transmit a connection request to the user using the routing address. In some embodiments, the applications server is further configured to connect the user to the communication session. In some embodiments, the determination of the routing address for the communication session is further based on a characteristic of the user. In some embodiments, the characteristic is a technical skill associated with the user. In some embodiments, the analytics engine is further configured to evaluate a performance of the user based on obtained information about the actual call flow of the communication session received after the user has connected to the communication session.

In some embodiments, the techniques described herein relate to a method, the method including: monitoring a communication session; obtaining information about an actual call flow of the communication session; sending the obtained information about the actual call flow of the communication session to an analytics engine; and determining, based on an analysis of the obtained information about the actual call flow of the communication session, a routing address for the communication session, wherein the determination occurs during the communication session. In some embodiments, the routing address is associated with a user. In some embodiments, the method further includes transmitting a connection request to the user using the routing address. In some embodiments, the method further includes connecting the user to the communication session. In some embodiments, the determination of the routing address for the communication session is further based on a characteristic of the user. In some embodiments, the characteristic is a technical skill associated with the user. In some embodiments, the method further includes evaluating a performance of the user based on obtained information about the actual call flow of the communication session received after the user has connected to the communication session.

In some embodiments, the techniques described herein relate to a non-transitory computer-readable medium having stored therein a program which, when executed by a processor, causes the processor to perform a method, the method including: monitoring a communication session; obtaining information about an actual call flow of the communication session; sending the obtained information about the actual call flow of the communication session to an analytics engine; and determining, based on an analysis of the obtained information about the actual call flow of the communication session, a routing address for the communication session, wherein the determination occurs during the communication session. In some embodiments, the routing address is associated with a user. In some embodiments, the method further includes transmitting a connection request to the user using the routing address. In some embodiments, the method further includes connecting the user to the communication session. In some embodiments, the determination of the routing address for the communication session is further based on a characteristic of the user. In some embodiments, the method further includes evaluating a performance of the user based on obtained information about the actual call flow of the communication session received after the user has connected to the communication session.

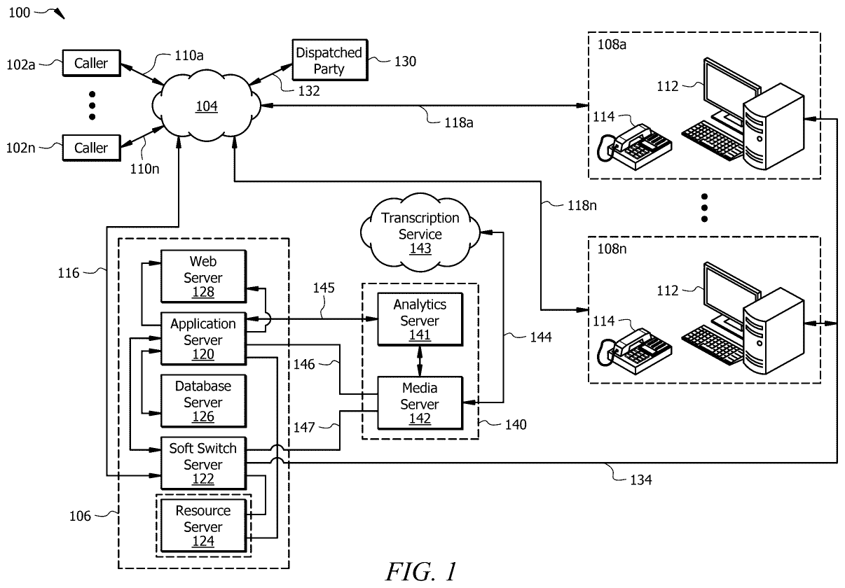

Embodiments of the present disclosure and its advantages may be understood by referring to FIGS. 1, 2, and 3, with like numerals being used for like and corresponding parts of the various drawings.

FIG. 1 is a block diagram of an example communication system 100, in accordance with certain embodiments. More particularly, FIG. 1 illustrates communication system 100 comprising one or more callers 102a-102n, a service platform 106, an analytics engine 140, one or more operator stations 108a-108n, and one or more dispatched parties 130. Although FIG. 1 illustrates one example of communication system 100, it should be understood that this is for purposes of example only and the present disclosure is not limited to the example communication system of FIG. 1. Rather, the present disclosure contemplates that other embodiments of system 100 may be used without departing from the scope of the present disclosure.

In the example embodiment of FIG. 1, callers 102a-102n, service platform 106, operator stations 108a-108n, and dispatched parties 130 are coupled to network 104 through various communications links. As used throughout this document, the term “couple” and/or “coupled” refers to any direct or indirect communication between two or more elements, whether those elements are in physical contact with one another. For example, each caller 102 may use any computing and/or communication device capable of enabling the communication of information to or from one or more of service platform 106, operator stations 108, and dispatched party 130 over network 104. Although referred to herein as a caller, callers 102 are not limited to individuals or devices that initiate a telephone call. Rather, the present disclosure contemplates that callers 102 may engage in a variety of types of communication sessions (e.g., telephone calls, video conferencing, text message, or web chat). It should also be understood that a caller 102 is not limited to a party initiating a communication session. For example, callers 102a-102n may be a calling party or a called party that communicates and/or receives data to and/or from service platform 106, operator stations 108, and/or dispatched party 130. Each caller 102 may use, for example, a telephone (e.g., a wireline telephone), a wireless device (e.g., a smartphone), a voice over Internet Protocol (IP) device, a desktop computer, a laptop computer, a personal digital assistant (PDA), a workstation, a mainframe computer, a mini-frame computer, a web server, or any other computing and/or communicating device.

Network 104 may comprise any wireless network, wireline network, or combination of wireless and wireline networks capable of supporting communication between network elements using ground-based and/or space-based components. For example, network 104 may comprise a data network, a public switched telephone network (PSTN), an integrated services digital network (ISDN), a local area network (LAN), a wide area network (WAN), a metropolitan area network (MAN), all or a portion of the global computer network known as the Internet, and/or other communication systems or combination of communication systems at one or more locations.

Service platform 106 receives and/or communicates data (e.g., from or to callers 102a-102n, operator stations 108, and/or dispatched party 130) through network 104 coupled to service platform 106. In the example of FIG. 1, service platform 106 couples to network 104 through communications link 116. In certain embodiments, service platform 106 operates to collect, store, and/or communicate data to and/or from network 104. In certain embodiments, service platform 106 may be configured to integrate with, for example, telephone carriers and private branch exchange (PBX) equipment to provide a stand-alone, fully functional call-center environment. In some cases, the carrier and PBX integration may be established using a Session Initiation Protocol (SIP) trunk integration method. In operation, service platform 106 may provide a full suite of call-center and enterprise functionality. The various elements of service platform 106 and exemplary functionality of service platform 106 are described in more detail below.

In the example embodiment of FIG. 1, system 100 also includes a plurality of operator stations 108a through 108n. Operator stations 108a through 108n are coupled to service platform 106 through communications link 134. Operator stations 108 are capable of receiving, collecting, storing, and/or communicating data to and/or from network 104. In the example embodiment of FIG. 1, operator stations 108a through 108n are coupled to network 104 through communications links 118a and 118n, respectively.

In certain embodiments, operator stations 108a through 108n may be in a call-center. For example, each operator station 108 may be a live agent-based data collection system capable of collecting data from, for example, caller 102 or dispatched party 130. Although operator station 108 is an agent-based system in the example embodiment of FIG. 1, the present disclosure contemplates that other suitable data collection systems may be used without departing from the scope of the present disclosure.

As used herein, the term agent should be interpreted broadly to encompass any individual that caller 102 may be connected to, whether as part of an incoming call from caller 102 routed to service platform 106 or as part of an outgoing call transmitted from service platform 106 to a user (e.g., caller 102). As non-limiting examples, an agent may refer to an agent working in a call-center (e.g., at one of operator stations 108), an employee of an organization associated with service platform 106 and/or operator stations 108, a technician (that may or may not be working remotely from a call-center), speech-enabled intelligent script, or any other suitable person or entity. Although certain embodiments may describe an agent as an operator associated with an operator station 108 in a call-center, the present disclosure is not limited to such an example embodiment. Rather, the various embodiments described herein may be applied to other suitable scenarios, such as those in which operator stations 108 do not make up a traditional call-center (having a plurality of operator stations in one, centralized location). For example, in certain embodiments operator stations 108 may be distributed geographically and may couple to service platform 106 and caller 102 via one or more different networks.

Operator stations 108 may comprise any suitable computing and/or communicating device or combination of devices. In the example embodiment of FIG. 1, each operator station 108 includes a host 112 and a communication device 114. Communication device 114 enables an agent to communicate with caller 102. Communication device 114 may comprise, for example, a telephone, a wireless device, a voice over IP device, or any other computing and/or communicating device or combination of devices. Although the example embodiment of FIG. 1 illustrates host 112 and communication device 114 as separate devices, one device that is capable of performing the desired functionality could be used without departing from the scope of the present disclosure.

Host 112 may comprise, for example, a desktop computer, a laptop computer, a server computer, a personal digital assistant, and/or any other computing or communicating device or combination of devices. In certain embodiments, host 112 may be connected to a PBX-based automated call distribution (ACD) or an ACD of service platform 106. Host 112 may be configured to run software, such as a soft agent. The soft agent may, for example, include a SIP-based soft phone and switch-specific computer telephony integration (CTI) control of the agent state during call handling. The soft agent may provide an interface to service platform 106, and in particular to applications server 120 and softswitch server 122 of service platform 106. Host 112 may include a graphical user interface (GUI) that enables a live agent to collect, enter, process, store, retrieve, display, amend, and/or dispatch data during the interaction of operator station 108 with a user of caller 102 or dispatched party 130 (e.g., during a call). Host 112 may run console software that provides, for example, IP-based call handling using the GUI and, for example, an input device (such as a mouse, keyboard, microphone, or other suitable input device).

Dispatched party 130 may be associated with a business or other entity that has engaged a call-center to manage incoming and/or outgoing calls. In the example of FIG. 1, dispatched party 130 is coupled to network 104 through communications link 132. Like caller 102 described above, dispatched party 130 may use any computing and/or communication device capable of enabling the communication of information to or from one or more of service platform 106, operator stations 108, and callers 102 over network 104. For example, dispatched party 130 may use a telephone (e.g., a wireline telephone), a wireless device (e.g., a smartphone), a voice over IP device, a desktop computer, a laptop computer, a PDA, a workstation, a mainframe computer, a mini-frame computer, a web server, or any other computing and/or communicating device.

As noted above, in the example embodiment of FIG. 1 callers 102a-102n, service platform 106, operator stations 108-108n, and dispatched party 130 are coupled to network 104 through various communications links. More particularly, system 100 includes communications links 110, 116, 118, 132 and 134, each operable to facilitate the communication of data to and/or from network 104. Likewise, system 100 includes communication links 144, 145, 146, and 147, each operable to facilitate the communication of data to and/or from analytics engine 140. Communications links 110, 116, 118, 132, 134, 144, 145, 146, and 147 may include any hardware, software, firmware, or combination thereof. In various embodiments, communication links 110, 116, 118, 132, 134, 144, 145, 146, and 147 may comprise communications media capable of assisting in the communication of analog and/or digital signals. Communications links 110, 116, 118, 132, 134, 144, 145, 146, and 147 may, for example, comprise a twisted-pair copper telephone line, a fiber optic line, a Digital Subscriber Line (DSL), a wireless link, a USB bus, a PCI bus, an ethernet interface, or any other suitable interface operable to assist in the communication of information.

Data may be transmitted over communications links 110, 116, 118, 132, 134, 144, 145, 146, and 147 using any suitable protocol. As non-limiting examples, protocols such as the Real-time Transport Protocol (RTP) and WebRTC may be used. RTP is a network protocol for delivering audio and video over IP networks via streaming. WebRTC is an open framework for the web that enables high quality real-time communication sessions over a network. WebRTC allows for the streaming of audio and/or video media without requiring an intermediary or third-party software. RTP and WebRTC may be particularly useful in the various embodiments described herein, because they can advantageously allow for the receipt of real-time data from the communication session between caller 102 and an agent associated with an operator station 108, if desired.

As noted above, service platform 106 may provide a full suite of call-center and enterprise functionality. Service platform 106 may comprise any suitable combination of hardware, software, and/or firmware. In certain embodiments, service platform 106 may comprise any device or combination of devices that may include one or more software and/or firmware modules. In the example embodiment of FIG. 1, service platform 106 includes an applications server 120, a softswitch server 122, a resource server 124, a database server 126, and a web server 128. Although FIG. 1 illustrates a particular arrangement of elements of service platform 106, it should be understood that the present disclosure is not limited to the precise arrangement of the example embodiment of FIG. 1. For example, although FIG. 1 illustrates an example embodiment in which applications server 120, softswitch server 122, resource server 124, database server 126, and web server 128 are incorporated into a single device, the present disclosure is not limited to this example embodiment. In certain embodiments, the elements of service platform 106 may be distributed. In certain embodiments, service platform 106 may contain fewer components than those illustrated in the example embodiment of FIG. 1. For example, in certain embodiments, the functions of resource server 124 may be performed by media server 142, explained in greater detail below with respect to analytics engine 140. Additionally, in certain embodiments service platform 106 may contain any suitable additional components that may provide one or more of the functionalities described herein and/or additional functionality to service platform 106.

Applications server 120 may house one or more applications used by service platform 106. In certain embodiments, applications server 120 may provide a full suite of call-center and enterprise applications. Exemplary call-center and enterprise applications provided by applications server 120 are described in more detail below.

Softswitch server 122 is coupled to applications server 120 and resource server 124 in the example embodiment of FIG. 1. Softswitch server 122 may house the switching components of service platform 106. For example, softswitch server 122 may include a softswitch. In certain embodiments, the softswitch may be a SIP-based telephony switch. The softswitch may receive inbound phone calls (e.g., from callers 102) and send outgoing call requests (e.g., outbound calls from operator stations 108). The softswitch may provide telephony services to, for example, IP subscribers and traditional PSTN subscribers, for example by supplying the trunking between the IP and PSTN networks. Softswitch server 122 may operate in tandem with one or more of applications server 120, resource server 124, database server 126, web server 128, and media server 142 to provide voice processing and switching resources. For example, softswitch server 122 may provide one or more of intelligent call routing, switch-based configurable call control, multi-lingual voice processing resources, and other suitable functionality. In certain embodiments, softswitch 122 may stream audio or video to media server 142 for processing (for example, using the speech recognition functionality of media server 142, described in more detail below).

In the example embodiment of FIG. 1, resource server 124 is coupled to applications server 120 and softswitch server 122. In certain embodiments, resource server 124 may operate in tandem with one or more of applications server 120, softswitch server 122, database server 126, and web server 128 to provide voice processing resources for service platform 106. For example, resource server 124 may provide a speech recognition engine and voice resources for service platform 106. Resource server 124 may include an automatic speech recognition (ASR) engine capable of processing voice responses, natural language processing, text-to-speech translations, and/or speech-to-text translations in connection with one or more voice-enabled functions of service platform 106. In certain embodiments, resource server 124 can be configured to use one or more customizable grammars to match spoken phrases to, for example, directory listings. Resource server 124 may be configured to receive audio from softswitch server 122 for processing using the speech-recognition functionalities described above. In certain embodiments, some or all the functionality described above as performed by resource server 124 may be performed by media server 142.

Database server 126 is coupled to applications server 120. Database server 126 may store information utilized by one or more other elements of service platform 106 (such as applications server 120, softswitch server 122, resource server 124, and web server 128) or analytics engine 140 (such as analytics server 141 and media server 142). For example, database server 126 may store one or more of information associated with dispatched party 130, information associated with a caller 102 (e.g., called or calling party), selections and data inputs from caller 102, recorded audio, transcripts of communication sessions, speech recognition patterns, and any other suitable information. In certain embodiments, database server 126 may use an SQL server database engine for database management, storage, and retrieval. Database server 126 may include memory capable of storing data associated with dispatched party 130, data associated with a caller's response or responses, information related to previous interactions between a caller and service platform 106 and/or a caller and an agent, and/or any other suitable information. The memory may include any hardware, software, firmware, or combination thereof operable to store and facilitate retrieval of information. The memory may store information using any of a variety of data structures, arrangements, and/or compilations. The memory may, for example, include a dynamic random-access memory (DRAM), a static random-access memory (SRAM), a NAND flash memory, and/or any other suitable volatile or nonvolatile storage and retrieval device or combination of devices.

Data stored in database server 126 may be accessible by multiple components of service platform 106 and/or operator stations 108 (including, for example, host 112 described in more detail below). For example, the data stored in database 126 may be accessible to one or more of applications server 120, softswitch server 122, resource server 124, web server 128, and host 112. Storing data in a memory that is accessible to multiple elements of system 100 can prove advantageous when it is desired to subsequently access and process this information. In certain embodiments, analytics server 141 and/or media server 142 may directly and/or indirectly (e.g., via applications server 120) access the data stored in database server 126. In certain embodiments, data stored in database server 126 can be used to determine an appropriate dispatched party 130 and/or routing address for a communication session. As used throughout this document, the term “routing address” may refer to any information or indication useable to direct a communication to a dispatched party 130.

Web server 128 provides the web services for service platform 106. In certain embodiments, web server 128 may provide access to the data stored in database server 126 (e.g., directly and/or indirectly). In certain embodiments, web server 128 may provide direct access to the data stored in database server 128. In certain embodiments, web server 128 may provide indirect access to database server 126 (e.g., through applications server 120). In certain embodiments, web server 128 may provide direct access to the information stored in analytics server 141. In certain embodiments, web server 128 may provide indirect access to the information stored in analytics server 141 (e.g., through applications server 120). Web server 128 may provide administrative, monitoring, and reporting tools for the information stored in the database server 126 and/or analytics server 141.

In certain embodiments, service platform 106 may include all or some suitable combination of the servers described above, as well as (alternatively or in addition to) other elements configured to perform desired communicating and/or computing functionality.

Each of applications server 120, softswitch server 122, resource server 124, database server 126, and web server 128 may comprise any suitable combination of hardware, software, and firmware. In certain embodiments, one or more of applications server 120, softswitch server 122, resource server 124, database server 126, and web server 128 may include processing circuitry, such as a combination of one or more of a controller, microprocessor, microcontroller, central processing unit, digital signal processor, application-specific integrated circuit, field programmable gate array, or any other suitable computing device, resource, or combination of hardware, software, and/or encoded logic operable to provide the functionality described herein. The processing circuitry may execute instructions stored in device readable medium or in memory to provide the functionality described herein. Applications server 120, softswitch server 122, resource server 124, database server 126, and web server 128 may comprise any form of volatile or non-volatile computer readable memory including, for example, persistent storage, solid-state memory, remotely mounted memory, magnetic media, optical media, random access memory (RAM), read-only memory (ROM), mass storage media (for example, a hard disk), removable storage media (e.g., a flash drive, a Compact Disk (CD) or a Digital Video Disk (DVD)), and/or any other volatile, non-transitory device readable and/or computer executable memory devices that store information, data, and/or instructions that may be used by the processing circuitry. The memory may store any suitable instructions, data, or information, including a computer program, software, an application including one or more of logic, rules, code, tables, etc. and/or other instructions capable of being executed by the processing circuitry to perform the various functionalities described herein. In some cases, the processing circuitry and device readable medium may be considered to be integrated.

In certain embodiments, one or more of applications server 120, softswitch server 122, resource server 124, database server 126, and web server 128 may run on dedicated servers. In certain embodiments, one or more of applications server 120, softswitch server 122, resource server 124, database server 126, and web server 128 may run in a virtual server environment. Running applications server 120, softswitch server 122, resource server 124, database server 126, and web server 128 in a virtual server deployment may advantageously reduce the number of servers needed and provide greater flexibility in terms of redundancy and case of deployment.

As noted above, applications server 120 may house one or more applications used by service platform 106 to provide a full suite of call-center and enterprise applications. For example, applications server 120 may provide various voice services (alone or in combinations with, for example, one or more of softswitch server 122, resource server 122, and media server 142). For instance, applications server 120 may provide call-center functions such as playing greetings to callers with multi-level navigation menus, playing automated call queuing announcements, playing automated agent greetings, automated call recording and playback, and other suitable functions. In certain embodiments, applications server 120 may provide for automated outbound phone calls (e.g., calls to one or more of callers 102) with messages played using integrated text-to-speech.

In certain embodiments, applications server 120 may determine how incoming and/or outgoing calls should be routed and provide instructions to softswitch server 122 to route calls and/or messages in a particular manner. In certain embodiments, applications server 120 may be configured to receive and process data and analysis from analytics engine 140 and to provide instructions to softswitch server 122. For example, as will be explained in greater detail below, analytics engine 140 may be configured to identify patterns and structures within information about a communication session using an artificial intelligence model to determine an appropriate dispatched party 130 and/or routing address for a call or message. Applications server 120 may receive analysis from analytics engine 140 and create routing instructions for softswitch server 122. In certain embodiments, the analysis is received in real-time (i.e., concurrently with the analyzed communication session) or near real-time. In certain embodiments, applications server 120 may be configured to provide instructions for routing calls and/or messages to softswitch server 122 without receiving real-time analysis from analytics engine 140. For example, applications server 120 may apply a tuned decision algorithm or decision tree to create routing instructions for softswitch server 122. In certain embodiments, the tuned decision algorithm or decision tree may be created and/or tuned by analytics engine 140 prior to its application by applications server 120. In certain embodiments, the tuned decision algorithm or decision tree may be periodically updated.

In certain embodiments, applications server 120 may send dispatch instructions to softswitch server 122. In certain embodiments, the dispatch instructions are received at applications server 120 from analytics engine 140. In certain embodiments, the dispatch instructions 122 are generated in applications server 120. In certain embodiments, softswitch server 122 sends a request for a dispatched party 130 to join a communication based on the dispatch instructions. In certain embodiments the request may be in the form of a phone call (e.g., from operator station 108). In certain embodiments, the request may be received as a notification from a mobile phone application. In certain embodiments, dispatched party 130 may accept or decline the request to join the communication session. In certain embodiments, accepting the request involves clicking a button associated with a link enabling the dispatched party to join the communication session. In certain embodiments, interacting with the button causes the mobile device to call a hidden telephone number which connects dispatched party 130 to the communication session through the system of the present disclosure. In certain embodiments, the actual phone number is not directly visible to the user, but when the user interacts with the link (e.g., by clicking on it), the phone call is initiated to the hidden number. In certain embodiments, the call to the hidden number is received at the soft-switch server 122 and the received call is merged with the existing communication session.

In certain embodiments, analytics engine 140 may be operatively coupled to applications server 120 through communications links 145 and 146. In certain embodiments, analytics engine 140 may comprise analytics server 141 and media server 142. In certain embodiments, applications server 120 may be configured to monitor and obtain information about the actual call flow of the communications sessions. In certain embodiments, applications server 120 may be configured to send the obtained information to analytics engine 140. In certain embodiments, application server 120 may, additionally or alternatively, be configured to send other information to analytics engine 140 including any information relevant to the obtained information about the actual call flow of the communication session stored in database server 126.

In the example embodiment of FIG. 1, analytics engine 140 includes an analytics server 141 and a media server 142. Although FIG. 1 illustrates a particular arrangement of elements of analytics engine 140, it should be understood that the present disclosure is not limited to the precise arrangement of the example embodiment of FIG. 1. For example, although FIG. 1 illustrates an example embodiment in which the analytics server 141 and media server 142 are located in the same device, the present disclosure is not limited to this example embodiment. In certain embodiments, the elements of analytics engine 140 may be distributed. In certain embodiments, analytics engine 140 may contain fewer components than those illustrated in the example embodiment of FIG. 1. Additionally, in certain embodiments analytics engine 140 may contain any suitable additional components that may provide one or more of the functionalities described herein and/or additional functionality of analytics engine 140. In a preferred embodiment, analytics engine 140 is cloud-based.

In the example of FIG. 1, analytics server 141 is coupled to applications server 120 using communications link 145 and media server 142. Analytics server 141 receives information about the actual call flow of the communication session from applications server 120. The information about the actual call flow of the communication session may include transcripts of the communication session, audio or visual recordings of the communication session, information about dispatches, notes taken by the agent or an auditing client, information about prior communication sessions with the customer, or any other relevant information about the actual call flow of the communication session. As will be explained in greater detail below, the analytics server 141 (within analytics engine 140) may use an artificial intelligence model to analyze the information about the actual call flow of the communication session to determine dispatch instructions for a call and/or message associated with the analyzed communications session and/or evaluate the performance of dispatched party 130.

In the example embodiment of FIG. 1, media server 142 is coupled to applications server 120, softswitch server 122, and transcription service 143. Media server 142 may be configured to receive streamed audio or video data for the communication session from softswitch server 122. In certain embodiments, media server 142 receives a stream of audio data from the softswitch server 122 and sends it to transcription service 143 for transcription over communication link 144. When media server 142 receives the transcript from transcription service 143, it may send the transcript to one or more of applications server 120 using communications link 146 and analytics server 141. In certain embodiments, media server 142 may not send data to transcription service 143 and instead processes the data itself. For example, media server 142 may provide a speech recognition engine and voice resources for service platform 106 and analytics engine 140. Media server 142 may include an automatic speech recognition (ASR) engine capable of processing voice responses, natural language processing, text-to-speech translations, and/or speech-to-text translations in connection with one or more voice-enabled functions of service platform 106 and analytics engine 140. For example, media server 142 may convert text to audio and send the audio to softswitch server 122 for playback. As discussed above, in certain embodiments media server 142 may replace resource server 124 and provide similar functionality.

In certain embodiments, media server 142 (alone or operating in combination with transcription service 143) is configured to generate a transcript of each of the communication sessions and send the generated transcript of each of the communication sessions to one or more of applications server 120 and analytics server 141. In certain embodiments, the generation of the transcript and the sending of the generated transcript may occur simultaneously and in real-time.

In operation, in certain embodiments, applications server 120 may be configured to monitor a plurality of communication sessions established between an agent (e.g., an agent associated with an operator station 108) and a caller 102. The communication sessions may be an audio and/or video communication sessions (e.g., a telephone call or video conference). As another example, the communication sessions may be written communication sessions (e.g., over text message or web chat). As still another example, the communication sessions may be communication sessions established between a caller 102 and a speech-enabled intelligent script. In the context of this disclosure, an intelligent script guides users (e.g., an agent) through call completion steps, workflow steps, and messaging steps. Intelligent scripts can be built for call-center agents, operators, and web and mobile users. Speech-enabled intelligent scripts enable users (e.g., caller 102) to interact with intelligent scripts without agent involvement. For example, phone users may be guided through scripts using pre-recorded prompts, voice menus, and text-to-speech menus.

In certain embodiments, applications server 120 may be configured to obtain information about the actual call flow of each communication session. For example, applications server 120 may be configured to obtain information about the actual call flow between an agent (e.g., an agent associated with an operator station 108) and a caller 102. As described above, the information about the actual call flow may be one or more of a transcript of the communication session (e.g., a transcript of all or a portion of the communication session), audio or visual recordings of the communication session, information about dispatches, notes taken by the agent or an auditing client, information about prior communication sessions with the caller, or any other relevant information.

In certain embodiments, applications server 120 may be configured to send the obtained information about the actual call flow of each of the communication sessions to analytics engine 140 using communications link 145. For example, applications server 120 may be configured to stream obtained information about the actual call flow of the communication session in real-time to analytics engine 140. In other cases, the applications server 120 may send the obtained information about the actual call flow of the communication session to analytics engine 140 once the communication session has ended. In still other cases, application server 120 may send the information about the actual call flow of the communication session to analytics engine 140 at a designated time, such as during a period of low call volume. This may advantageously free up bandwidth for the call-center during peak times. In certain embodiments, the data may be sent in a binary format, such as Protobuff or any other binary format. In other cases, the data may be sent in a JSON format or any other suitable format.

In certain embodiments, analytics engine 140 is configured to analyze the received information about the actual call flow of the communication session to determine a routing address and/or identity of dispatched party 130 appropriate for the communication session. As described above, existing systems often use pre-defined routing lists for communication sessions. However, using a pre-defined routing list often fails to consider the context of the communication session and may lead to customer dissatisfaction and inefficient use of limited call center resources. Certain embodiments of the present disclosure use analytics engine 140 to advantageously analyze information about the actual call flow of a communication session to dynamically determine an appropriate dispatched party and/or routing address for a call or message. In certain embodiments, analytics engine 140 is configured to analyze received information about the actual call flow of the communication session to evaluate the performance of a dispatched party 130.

In certain embodiments, analytics engine 140 may use an artificial intelligence (“AI”) model, such as, for example, a Large Language Model (“LLM”), to process the information about the actual call flow of the communication session. In certain embodiments, the LLM is used to determine a dispatched party 130 or routing address for the communication session. In certain embodiments the LLM is used to evaluate the call performance of a dispatched party 130 who has joined a communication session. A LLM is an AI model that can understand human language-based text input and generate human-like responses. LLMs advantageously can recognize patterns in a language to generate useful responses. LLMs are typically built using deep learning techniques, specifically using a type of neural network called the transformer architecture.

In the present context, the LLM may be trained on appropriate data in order to generate a model capable of outputting desirable results for dispatching calls and/or evaluating the call performance of a dispatched party 130 who has joined the communication session. In certain embodiments, the LLM used by analytics engine 140 may be trained on publicly available data. LLMs trained on publicly available data advantageously can leverage large amounts of data for training (in some cases, the larger the training data set is the better results the LLM will provide). In certain embodiments, the LLM may be trained on private data only. Using an LLM trained on, or having access to, private data may advantageously allow for results to be tuned to specific applications and/or use-cases which may provide more accurate results related to those specific applications and/or use-cases. In certain embodiments, the LLM may be trained on a combination of public and private data. This may advantageously combine the benefits of LLMs trained on public and private data. In certain embodiments, the LLM may be trained on information associating a dispatched party 130 with information such as: a routing address, technical skills, evaluation data, availability, and/or other useful information. This list is non-exhaustive and additional useful information will be apparent to those of skill in the art.

In certain embodiments, training data for the LLM is collected concerning one or more potential dispatched parties 130. In certain embodiments, the information collected about potential dispatched parties 130 may be stored in database server 126. In certain embodiments, the training data may include a list of technical skills associated with each potential dispatched party 130. This data may be collected as part of a survey, assessment, monitoring scheme, certification program, or other appropriate technique. In certain embodiments, each potential dispatched party 130 may be associated with one or more technical skills. In certain embodiments, the training data additionally includes a proficiency rating for the technical skill(s). For example, a potential dispatched party 130 with the technical skill “speaks Spanish” may have an associated proficiency rating of “four stars out of five,” indicating an above average proficiency in this skill. As another example, a different potential dispatched party 130 may also have the technical skill “speaks Spanish” but his proficiency rating for this skill may be “one star out of five,” indicating a beginner level proficiency with this skill. In certain embodiments, the proficiency level of a technical skill may be considered by analytics engine 140 when determining an appropriate dispatched party 130 for a given call and/or message. For example, with reference to the examples above, analytics engine 140 may determine the first dispatched party 130 is appropriate to dispatch a call and/or message to over the second dispatched party 130 when the analyzed communication session is with a caller 102 who prefers to speak Spanish. Although the examples above use a star system, a person of skill in the art would recognize that other ratings systems may be used.

In certain embodiments, the training data may include information based on an evaluation of dispatched party 130 during one or more monitored communication sessions. In addition to technical skills, personal communication skills play an important role in achieving customer satisfaction. Some dispatched parties 130 may perform better than others during communication sessions with callers 102 based on personal communication skills. In certain embodiments, communication sessions established between dispatched parties 130 and callers 102 may be monitored and evaluated. In certain embodiments, transcripts or other information pertaining to communications sessions between dispatched parties 130 and callers 102 may be stored in database server 126. As described in further detail below, in certain embodiments, the personal communication skills of dispatched parties 130 may be evaluated by analytics engine 140 and may be used to further train analytics engine 140.

In certain embodiments, training data may include data about callers 102. The information collected from callers 102 may be stored in database server 126. This data may be collected as part of a survey, assessment, monitoring scheme, or other appropriate technique. In certain embodiments, the training data includes information about previous communication sessions involving callers 102. In certain embodiments, the training data includes biographical information about callers 102. In certain embodiments, information about caller 102 is associated with the caller 102's name. In certain embodiments, information about caller 102 is associated with the caller 102's phone number. In certain embodiments, information about caller 102 is associated with an identification number associated with the caller 102.

In certain embodiments, the training data may include other relevant data (e.g., data collected and stored on database server 126). Other relevant data may include work schedules, company policies, billing rates for dispatched parties 130 and/or relevant laws. This information may be stored in database server 126. In certain embodiments, training data may be collected from multiple clients. For example, the training data may include all clients in a particular category or field. This may advantageously allow for a more robust data set to be used to create and apply the model used by analytics engine 140 (generally the more data in a training data set, the more accurate an artificial intelligence model becomes).

In certain embodiments, the identity of a dispatched party 130 is determined by analytics engine 140. For example, applications server 120 may provide an input (e.g., a prompt) asking analytics engine 140 to determine the ideal dispatched party 130 for a particular communication session. Along with the prompt, applications server 120 may provide information about the actual call flow of the communication session to analytics engine 140 within the allowed context window of the input field for the LLM. A context window refers to the amount of text the model can receive as input. Analytics engine 140 may send the identity of dispatched party 130 to applications server 120 to identify an appropriate routing address associated with the dispatched party 130. In certain embodiments, the applications server 120 may access a look-up table stored on database server 126 to determine the routing address associate with an identified dispatched party 130. In certain embodiments, analytics engine 140 may identify multiple appropriate dispatched parties 130 and send them to applications server 120.

In certain embodiments, analytics engine 140 may send the routing address associated with the determined dispatched party 130 to applications server 120 instead of the identity of dispatched party 130. In certain embodiments, the dispatched party 130 may be associated with multiple routing addresses. In certain embodiments the multiple routing addresses are associated with different methods of communication. For example, the dispatched party 130 may have a first routing address associated with a workstation. The dispatched party 130 may have a second routing address associated with a cellphone. The dispatched party may have a third routing address associated with an email account. Additional or alternative methods of communication may be used in various embodiments. In certain embodiments, the communication method allows for two-way communication allowing the dispatched party 130 to confirm receipt of a message. In certain embodiments, the dispatched party 130 indicates using a two-way communication method that the dispatched party 130 is taking action in response to a message. In certain embodiments, analytics engine 140 may determine which routing address associated with dispatching party 130 will result in the fastest response time at a given time for a specific communication session. For example, during work hours a routing address of an office phone number may result in the fastest response while after-hours a routing address associated with a cellular phone may result in fastest response time.

In certain embodiments, analytics engine 140 may determine which routing address associated with the dispatched party or identity of dispatched party 130 is most appropriate for a communication session based on other factors. Nonlimiting examples of other factors that may be used by analytics engine 140 may include requirements/preferences of a specific caller 102. For example, caller 102 may have an expressed preference by caller 102 for a certain type of communication, handicaps or disabilities associated with caller 102, and/or the type of communication session. In certain embodiments, the factors may include a caller's history of interactions with one or more dispatched parties 130. For example, analytics engine 140 may determine a specific dispatched party 130 is an appropriate destination user 130 for a communication session based on a previous positive interaction with a specific caller 102. As another example, analytics engine 140 may determine a specific dispatched party 130 is inappropriate for a communication session based on a previous negative interaction with a specific caller 102. Whether a communication session included a positive or negative interaction may be determined based on, for example, sentiment of caller 102 during the communication session, call outcome, the sentiment of caller 102 after the call (e.g., as measured by a post-call survey), or other indications.

In certain embodiments, analytics engine 140 may determine, based on the previous call history and call outcomes of communication sessions with a specific caller 102, whether a speech-enabled intelligent script is an appropriate dispatched party 130 for a specific caller 102. In certain embodiments, analytics engine 140 may recommend a speech-enabled intelligent script as the dispatched party 130 even if there is a negative difference in outcomes and/or caller sentiment between speech-enabled intelligent scripts so long as the difference is below a threshold. In certain embodiments, the threshold may change depending on the busyness of the call center and/or the availability of other dispatched parties 130. For example, analytics engine 140 may determine that an appropriate dispatched party 130 for a communication session is a speech-enabled intelligent script despite previous communication sessions with a specific caller 102 indicate a moderate negative difference in caller sentiment if all other dispatched parties 130 are unavailable. Analytics engine 140 may make a different determination if other dispatched parties 130 are available for routing.

In certain embodiments, analytics engine 140 may determine that routing to specific dispatched parties 130 results in a higher number of positive call outcomes as compared to other dispatched parties 130. In certain embodiments, analytics engine 140 may determine that certain dispatched parties 130 results in a higher number of positive call outcomes as compared to other dispatched parties 130 for specific call types. In certain embodiments, a low call response time may be considered a positive call outcome. In certain embodiments, analytics engine may evaluate communication sessions involving these dispatched parties 130 to determine tips and techniques for sharing and/or recommending to other dispatched parties 130. In certain embodiments, the analytics engine 140 may generate a report of high performing dispatched parties 130 and transmit the report to service platform 106.

In certain embodiments, analytics engine 140 may be provided with a list of possible dispatched parties 130 in the context window of the input. In these embodiments, the analytics engine 140 may determine an appropriate dispatched party 130 from the provided list. In certain embodiments, the list of possible dispatched parties 130 provided by applications server 120 is based on the availability of dispatching party 130. For example, analytics engine 140 may determine the most appropriate dispatched party 130 from among the list of possible dispatched party 130 who are currently available.

In certain embodiments, the analytics engine 140 determines the most appropriate dispatched party 130 or routing address based on the most efficient method of reaching a dispatched party 130. In certain embodiments, the analytics engine 140 determines the most efficient method of reaching the appropriate dispatched party 130 based on the response times for each method of communication for previous interactions with a specific dispatched party 130 or group of dispatched parties 130 (e.g., email, sms text message, secure messaging mobile app, live phone call, automated phone call, etc.). In certain embodiments, the determination is further based on call type. In certain embodiments, the analytics engine 140 determines the most appropriate dispatched party 130 based on the average call response times of the dispatched party 130. In certain embodiments, the average call response times are further based on call-type. In certain embodiments, analytics engine 140 generates a report on the average response times for dispatched parties 130 based on call-type and sends it to service platform 106. In certain embodiments, some communication sessions involving caller 102 may be considered urgent. Analytics engine 140 may make separate determinations and analysis, similar to that described above, specifically as related to communication sessions considered urgent. In certain embodiments, dispatched parties 130 may be informed when a communication session is considered urgent.

In certain embodiments, the analytics engine 140 determines the most appropriate dispatched party 130 or routing address based on the location information of the dispatched party. In certain embodiments, the dispatched party 130 may report their location information. In certain embodiments, the dispatched party 130 may report they location at regular intervals. In certain embodiments, the reporting of location information may happen automatically. For example, a dispatched party 130's communication device may have a GPS and may automatically send location information to service platform 106 (which in turn may make the information available to analytics engine 140). In certain embodiments, analytics engine 140 may determine a correlation between the response times of dispatched party 130 and call response time and use that information in its determination of an appropriate dispatched party 130 for a communication session. For example, if a dispatched party 130's location information indicates the dispatched party 130 is at a movie theater or restaurant, analytics engine may determine that the dispatched party 130 would have a lower than normal response time and take that into account when determining an appropriate dispatched party 130 or routing address for routing a communication session. In certain embodiments, the location of dispatched party 130 considered based on ability to conduct a follow-up. For example, if a patient calls in with an urgent medical issue, analytics engine 140 may route to a dispatched party 130 close to the patient such that the dispatched party is able to reach the patient quickly (e.g., to administer care).

In certain embodiments (e.g., those discussed above), the other factors and/or additional information is provided to analytics engine in the context window of an LLM when determining a dispatched party 130 or routing address for a communication session. In certain embodiments, the analyses and determinations discussed above may be made by the analytics engine 140 during slow periods when the analytics engine is not otherwise engaged. In certain embodiments, the results of the analysis and determinations discussed above may be stored in database server 126. In certain embodiments, the results of the analysis and determinations discussed above may be used as training data. In certain embodiments, the prompt sent to the LLM may be modified based on the other factors and/or additional information.

In certain embodiments, analytics engine 140 may determine follow-up is necessary and cause service platform 106 to facilitate the follow-up. For example, in existing systems, a call that cannot be dispatched after hours that is typically faxed or emailed for the office to pick up in the morning for follow up. In certain embodiments of the system described herein, rather than faxing or emailing, service platform 106 may schedule an appointment and/or initiate an automated conference call between the caller 102 and the dispatched party 130 at an appropriate time.

In certain embodiments, the call performance of a dispatched party 130 is evaluated by analytics engine 140. In certain embodiments, after dispatched party 130 joins a communication session, analytics engine 140 continues to receive the information about the actual call flow of the communication session. In certain embodiments, analytics engine 140 receives information about the actual call flow of a communication session initiated by the dispatched party 130 after the initial communication session is over (e.g., a follow-up or return call). In certain embodiments, applications server 120 may provide an input (e.g., a prompt) asking analytics engine 140 to evaluate the performance of dispatched party 130. In certain embodiments, the results of the evaluation are associated with the dispatched party 130 and stored on database sever 126. In certain embodiments, the results of the evaluation may be used as training data for the LLM. In certain embodiments, the results of the evaluation may be included in a future input (e.g., prompt) to analytics engine 140. In certain embodiments, applications server may include specific criteria within the context window of the input field to analytics engine 140 for evaluation. A nonlimiting list of possible criteria for evaluation includes caller 102's sentiment, dispatched party 130's tone, dispatched party 130's word choice or vocabulary, dispatched party 130's technical accuracy, dispatched party 130's cadence, dispatched party 130's politeness and accuracy of greeting, dispatched party 130's confidence level, grammar, dispatched party 130's engagement with the caller, dispatched party 130's overall attitude, dispatched party 130's message handling, whether or not the dispatched party 130 verified certain information, call outcome, call closing, response time, the accuracy of any information provided and/or recorded by the dispatched party 130 and any other suitable criteria. In certain embodiments, caller 102's sentiment may include whether the caller 102 was angry, whether the caller 102 was happy, whether a follow-up call with caller 102 is necessary, trend data for the caller 102's sentiment, and/or whether the call was resolved to the satisfaction of caller 102. In certain embodiments, analytics engine 140 determines the impact of time on the performance of a dispatched party 130. For example, analytics engine 140 may determine that dispatched party 130 performs well in the morning but that their performance falls off after lunch. As another example, analytics engine 140 may determine that a dispatched party 130 performs well on Mondays and Fridays but not on other days of the week. In certain embodiments, the performance information of certain dispatched parties 130 may be added to the context window of the LLM to assist the analytics engine 140 in determining an appropriate dispatched user 130 and/or routing address for a communication session.

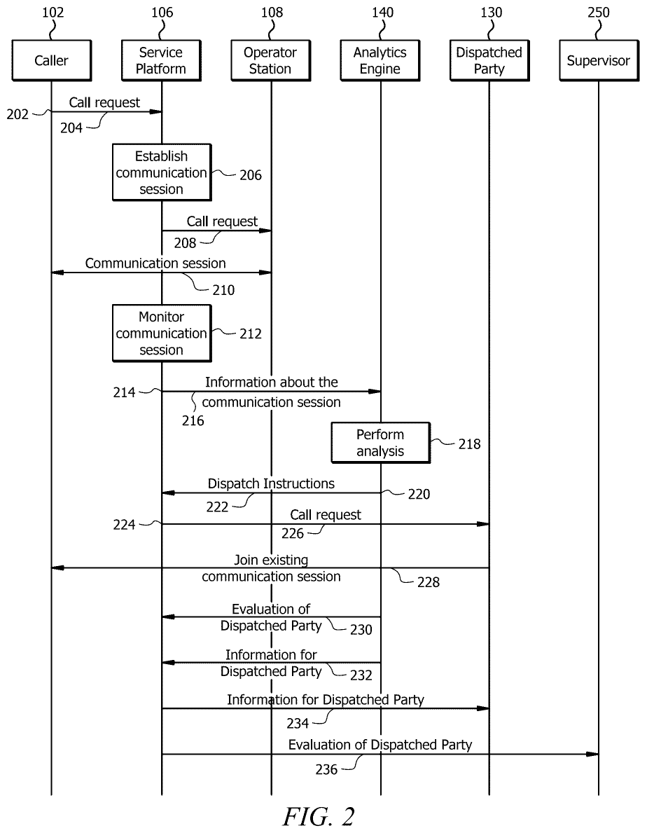

In certain embodiments, the evaluation of dispatched party 130 may be available in real-time or near real-time. In certain embodiments, the supervisor 250 (depicted in FIG. 2) may request an evaluation of dispatched party 130. In certain embodiments, a supervisor 250 of dispatched party 130 may be sent a notification with the results. In some embodiments, this notification may happen automatically. For example, if dispatched party 130 is evaluated poorly in one or more criteria, a supervisor 250 may receive a notification with the evaluation. In certain embodiments, the notification may contain a link for the supervisor 250 to join the communication session.

In certain embodiments, dispatched party 130 may be provided with tips and/or advice during the communication session or after the communication session on how to improve personal skills associated with the evaluated criteria. In certain embodiments, the tips and/or advice may be static and may be stored on database server 126. For example, database server 126 may store a predefined list of tips and/or advice related to specific common communication problems. The appropriate tips and/or advice may be selected based on keywords identified in the evaluation of dispatched party 130 and/or the information about the actual call flow of the communication session. In certain embodiments, the tips and/or advice is dynamic and is generated by analytics engine 140 by inputting a prompt requesting tips and/or advice tailored to dispatched party 130. The evaluation of dispatched party 130 and/or other information about the actual call flow of the communication session may be included within the context window of the input to analytics engine 140. In certain embodiments, service platform 106 may inform dispatched party 130 of any transcription errors when recoding information about caller 102. In certain embodiments, service platform 106 may make suggested corrections when errors or discrepancies are identified. In certain embodiments, service platform 106 may cause an engagement view to be displayed to the dispatched party 130 that displays all previous interactions with caller 102 regardless of which system or method of communication was used. In certain embodiments, the engagement view is filterable to display only the engagements desired by the viewing party.

In certain embodiments, dispatched party 130 and/or an agent of the call center may be provided with information during the call to assist dispatched party 130. For example, dispatched party 130 and/or the agent may be provided with caller sentiment while the call is in progress, information about previous interactions with caller 102, recommended responses to caller inquiries, and/or recommended call completion steps. In certain embodiments, recommended call completion steps may be accompanied by changes to the call script. For example, based on analysis of the actual call flow analytics engine 140 may offer suggestions to the dispatched party 130 about how they should interact with the caller. For example, analytics engine 140 may suggest scheduling a follow up appointment based on its analysis. In certain embodiments, service platform 106 may retrieve previous caller records and cause those records (or portions of those records) to be presented to the dispatched party 130 during the call. In certain embodiments, the records may be annotated or highlighted along with suggestions on whether the caller records may apply to the current situation.

In certain embodiments, the provided information to assist dispatched party 130 may be from an outside database (accessed, for example, using web server 128). For example, the provided information may be from a caller 102's medical record. In certain embodiments, service platform 106 may retrieve information from a caller 102's medical record. In certain embodiments, service platform 106 may add information to a caller 102's medical record as a result of the communication session. In certain embodiments the added information may be a transcript or summary of the communication session.

Besides the large language models (LLM) discussed above, other non-limiting examples of artificial intelligence models that may be used by analytics engine 140 may include a linear regression (SLR) model, a naïve bayes model, or a deep neural network (DNN). Analytics engine 140 may use any suitable artificial intelligence model.

Although certain exemplary embodiments have been described above in the context of handling an incoming telephone call, text message, or web chat received at a call-center from caller 102, the present disclosure is not limited to these example embodiments. Rather, the present disclosure contemplates that the various embodiments described herein may be applied to outgoing communications (e.g., telephone calls, text messages, or web chats) initiated at the call-center and directed to caller 102. Additionally, the various embodiments described herein are not limited to the exemplary forms of communication described and may be applied to other forms of communication. For example, the various embodiments described herein may be applied to multimedia communications (including, but not limited to, texting, chatting, and video communications). According to one example embodiment, a communication session may be established over a network, such as network 104, capable of delivering real-time audio and/or video media over IP networks via streaming without requiring an intermediary or third-party software, such as RTP and/or WebRTC. According to another example embodiment, a caller 102 may establish a communication session with an agent (e.g., an agent associated with a host 112 described above) using one of the above-described exemplary forms of multimedia communication or another suitable form of communication. In such a scenario, the called number may be an IP address, uniform resource locator (URL) or other information used to establish a multimedia communication session between the user and the agent. The communication session may be handled in accordance with the principles of the various embodiments described herein.

For instance, in certain embodiments a caller 102 may visit a web site associated with a company utilizing a call-center including service platform 106 described above. In some cases, the web site may include a “Contact Us” button or other suitable mechanism to enable the user to initiate a communication session with an agent (e.g., via one of the forms of multimedia communication described above). As an alternative, the web site may include an automated prompt presented to the user to enable the user to establish a communication session with the agent (e.g., a chat, text, or video conversation). In such a scenario, the information about the call flow provided to analytics engine 140 may comprise data transcripts of the communication session, audio or visual recordings of the communication session, information stored in cookies from the website, information associated with the caller 102 on their IP address, information about dispatches, notes taken by the agent or an auditing client, or any other relevant information about the actual call flow of the communication session 210. It should be understood, however, that other forms of establishing the communication session between caller 102 and an agent may be used.

FIG. 2 is an exemplary signal flow chart, in accordance with certain embodiments. For example, in certain embodiments the analytics engine 140 may provide information used to dispatch or route a call. In other embodiments, such as those show in FIG. 2, it may additionally evaluate the dispatched party 130 and/or provide information during the call. In particular, FIG. 2 illustrates an exchange of signals among a caller 102, service platform 106, operator station 108, analytics engine 140, dispatched party 130, and supervisor 250.

At step 202, caller 102 initiates a call by sending a call request 204 that is routed to service platform 106. For example, caller 102 may initiate a call to a call-center running service platform 106. As discussed above, it should be understood that calls are not limited to telephone calls. Rather, the present disclosure contemplates that calls may involve a variety of types of communication sessions (e.g., telephone calls, video conferencing, text message, or web chat).

At step 206, service platform 106 establishes a communication session 210 between caller 102 and an agent associated with an operator station 108. In particular, service platform 106 sends a call request 208 to operator station 108 to establish communication session 210.

At step 212, service platform 106 monitors the communication session for information about the actual call flow, for example as described above in relation to FIG. 1. As discussed above in relation to FIG. 1, information about the actual call flow of the communication session 210 may include data transcripts of the communication session, audio or visual recordings of the communication session, information about dispatches, notes taken by the agent or an auditing client, or any other relevant information about the actual call flow of the communication session 210. In some embodiments, the communication session continues to be monitored until the communication session terminates-including after the dispatched party 130 joins the communication session.

At step 214 service platform 106 streams information about the actual call flow of the communication session 216 to analytics engine 140. In certain embodiments, service platform 106 continues to stream information about the actual call flow of the communication session 216 to analytics engine 140 until the communication session 210 terminates-including after the dispatched party 130 is connected to the communication session 210. In certain embodiments, the analytics engine 140 is used to evaluate the performance of dispatched party 130 after dispatched party 130 joins communication session 210 as described with respect to FIG. 1.

At step 218, in response to receiving the information about the actual call flow of the communication session from service platform 106, analytics engine 140 analyzes the received information. In certain embodiments, analytics engine 140 determines an appropriate routing address and/or dispatched party 130 for the communication session. In certain embodiments, as discussed in relation to FIG. 1, analytics engine 140 evaluates the call performance of dispatched party 130. As discussed in relation to FIG. 1, in certain embodiments, analytics engine 140 may determine dispatch instructions 222 based on an artificial intelligence model. For example, analytics engine 140 may use a large language model, a simple linear regression model, naive bayes model, deep neural network, or other suitable artificial intelligence model to determine dispatch instructions 222. In some embodiments, steps 202-216 are performed repeatedly before moving on to step 218. This may advantageously give analytics engine 140 a more robust data set from which to analyze and determine dispatch instructions 222.

At step 220 analytics engine 140 sends the dispatch instructions 222 to service platform 106. In some embodiments, service platform 106 performs additional processing of dispatch instructions 222. For example, service platform 106 may validate the dispatch instructions 222 using data stored in database server 126 (e.g., client policies or availability information).

At step 224 service platform 106 sends call request 226 to dispatched party 130. In certain embodiments, the call request 226 is a telephone call that dispatched party 130 may choose to answer or not. In certain embodiments, the call request 226 is a notification appearing on, for example, a mobile phone application. In certain embodiments, the notification has a button that dispatched party 130 may use to join communication session 210. In certain embodiments, the button is associated with a hidden phone number. In certain embodiments, clicking the button causes the dispatched party 130's phone to call the hidden phone number which routes the dispatched party 130's call through the system. In certain embodiments, the communication session initiated by the call is encrypted. This may advantageously allow for widely available and/or common devices (e.g., a cellphone) to be used securely by the dispatched party 130 for the system described herein (e.g., as opposed to specialized hardware).

At step 228 dispatched party 130 joins the existing communications session. In certain embodiments, the dispatched party 130 receives real-time or near real-time feedback of the dispatched party 130's performance during the communication session, for example as described above in relation to FIG. 1.

In the example embodiment of FIG. 2, at step 230, analytics engine 140 sends evaluation data of dispatched party 130 to service platform 106. In certain embodiments, this facilitates feedback to both the dispatched party 130 or to supervisor 250 as described above in relation to FIG. 1. In certain embodiments the evaluation data may be used to further refine the LLM used by analytics engine 140.

At step 232, analytics engine 140 sends information for use by dispatched party 130 during the call to service platform 106. In certain embodiments, the information for use by dispatched party 130 may be advice or tips for the communication session as described above with respect to FIG. 1. In certain embodiments, the information for use by the dispatched party may be technical data or other records (e.g., records about previous interactions with caller 102).

At step 234, service platform 106 sends the information for use by dispatched party 130 during the call to the dispatched party 130. In certain embodiments, the information may be described on a graphical user interface. In certain embodiments, the graphical user interface may be displayed on the same device as the one used to initiate the call.

At step 236, the evaluation information of dispatched party 130 is sent by service platform 106 to supervisor 250. In certain embodiments, supervisor 250 of the dispatched party 130 may receive real-time or near real-time reports on the dispatched party 130's performance. In certain embodiments, the supervisor 250 is prompted to join the communication session if a triggering event occurs. Nonlimiting examples of triggering events include: one or more evaluated criteria for dispatched party 130 drops below a pre-defined threshold, the caller 102 is determined to be agitated or angry based on an analysis of caller sentiment, and/or any other appropriate trigger.

It should be understood that FIG. 2 illustrates one exemplary embodiment. It should be understood that the present disclosure contemplates that some steps may be omitted, added, or reordered without departing from the scope of the present disclosure.

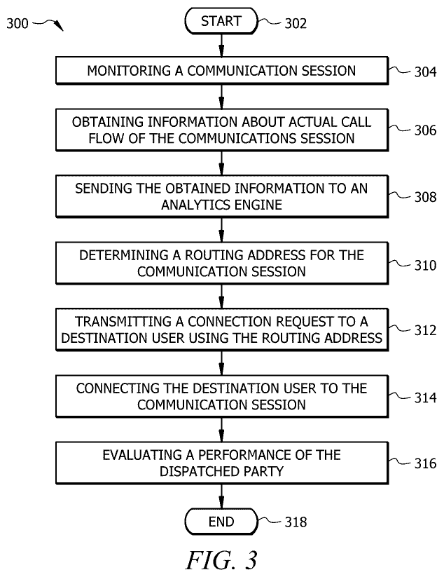

FIG. 3 is a flow diagram of an exemplary method 300, in accordance with certain embodiments. In certain embodiments, the method may be performed by a call-center service platform (e.g., service platform 106 described above in relation to FIG. 1). The method begins at step 302.

At step 304, a communication session is monitored. In certain embodiments, the monitoring of the communication session is continuous and ongoing until the communication session is terminated. More detail for techniques of monitoring of the communication session is described above with respect to FIG. 1.

At step 306, information about the communication session is obtained. More detail for what information is obtained and from what sources is described above with respect to FIG. 1. At step 308, the obtained information is sent to analytics engine 140. At step 310, analytics engine 140 determines a routing address for the communication session. More detail for techniques for determining a routing address are described above with respect to FIG. 1. For example, alternatively, analytics engine 140 may determine the identity of a dispatching party 130 and may provide that information to service platform 106 which may, in turn, determine the routing address.

At step 312, a connection requested is transmitted to a dispatched party using the routing address. More detail for techniques for transmitting a connection request are described above with respect to FIG. 1. At step 314, the dispatched party 130 is connected to the communication session. At step 316, the performance of the dispatched party during the communication session is evaluated. More detail for techniques for evaluating a performance of dispatched party 130 are disclosed with respect to FIG. 1. At step 318, the method ends.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components.

Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A system, the system comprising:
an applications server communicatively coupled to an analytics engine, wherein:
the applications server is configured to:
monitor a communication session;
obtain information about an actual call flow of the communication session; and
send the obtained information about the actual call flow of the communication session to the analytics engine; and
the analytics engine is configured to:
determine, based on an analysis of the obtained information about the actual call flow of the communication session, a routing address for the communication session, wherein the determination occurs during the communication session.

2. The system of claim 1, wherein the routing address is associated with a user.

3. The system of claim 2, wherein the applications server is further configured to transmit a connection request to the user using the routing address.

4. The system of claim 3, wherein the applications server is further configured to connect the user to the communication session.

5. The system of claim 2, wherein the determination of the routing address for the communication session is further based on a characteristic of the user.

6. The system of claim 5, wherein the characteristic is a technical skill associated with the user.

7. The system of claim 4, wherein the analytics engine is further configured to evaluate a performance of the user based on obtained information about the actual call flow of the communication session received after the user has connected to the communication session.

8. A method, the method comprising:
monitoring a communication session;
obtaining information about an actual call flow of the communication session;
sending the obtained information about the actual call flow of the communication session to an analytics engine; and
determining, based on an analysis of the obtained information about the actual call flow of the communication session, a routing address for the communication session, wherein the determination occurs during the communication session.

9. The method of claim 8, wherein the routing address is associated with a user.

10. The method of claim 9, the method further comprising transmitting a connection request to the user using the routing address.

11. The method of claim 10, the method further comprising connecting the user to the communication session.

12. The method of claim 9, wherein the determination of the routing address for the communication session is further based on a characteristic of the user.

13. The method of claim 12, wherein the characteristic is a technical skill associated with the user.

14. The method of claim 9, the method further comprising evaluating a performance of the user based on obtained information about the actual call flow of the communication session received after the user has connected to the communication session.

15. A non-transitory computer-readable medium having stored therein a program which, when executed by a processor, causes the processor to perform a method, the method comprising:
monitoring a communication session;
obtaining information about an actual call flow of the communication session;
sending the obtained information about the actual call flow of the communication session to an analytics engine; and
determining, based on an analysis of the obtained information about the actual call flow of the communication session, a routing address for the communication session, wherein the determination occurs during the communication session.

16. The computer-readable medium of claim 15, wherein the routing address is associated with a user.

17. The computer-readable medium of claim 16, wherein the method further comprises transmitting a connection request to the user using the routing address.

18. The computer-readable medium of claim 17, wherein the method further comprises connecting the user to the communication session.

19. The computer-readable medium of claim 16, wherein the determination of the routing address for the communication session is further based on a characteristic of the user.

20. The computer-readable medium of claim 16, the method further comprising evaluating a performance of the user based on obtained information about the actual call flow of the communication session received after the user has connected to the communication session.
